(19) United States
(12) Patent Application Publication
(10) Pub. No.: US 2005/0146996 A1
(43) Pub. Date: Jul. 7, 2005

(54) Digital music system for disc jockeys

(75) Inventor: Christopher Roman, Wrentham, MA (US)

Correspondence Address: BARLOW, JOSEPHS & HOLMES, LTD., 101 DYER STREET, 5TH FLOOR, PROVIDENCE, RI, 02903, US

(73) Assignee: Numark Industries, LLC, Cumberland, RI (US)

(21) Appl. No.: 11/028,707

(22) Filed: Jan. 4, 2005

Related U.S. Application Data
(60) Provisional application No. 60/534,295, filed on Jan. 5, 2004.

(51) Int. Cl. G11B 7/085

(52) U.S. Cl. 369/30.27

(57) ABSTRACT

The digital media system (10) for disc jockeys includes a digital storage drive (107). Preferably, the music system (10) has two media readers (110, 112). Audio files can be simultaneously recorded to the digital storage drive (107) and played therefrom. An operating system is included for managing the digital data of the digital storage drive (107). The music system (10) also includes an output and a control unit (200) for controlling the media readers (110, 112), digital storage drive (107), operating system, and output. The control unit (200) has a first and second interface (210, 212). The interfaces (210, 212) are capable of independently and selectively mixing digital data from the media readers (110, 112) and the storage drive (107) into a signal and routing the signal through the output.

### CROSS-REFERENCE TO RELATED APPLICATION

This application claims priority to earlier filed U.S. Provisional Application Ser. No. 60/534,295, filed Jan. 5, 2004, the contents of which are incorporated herein by reference.

### BACKGROUND OF THE INVENTION

The present invention relates general to digital storage-based music systems. In particular, the present invention relates to digital storage-based music systems, which are particularly well suited and specifically designed for use by disc jockeys.

In the music industry, digital storage-based music systems are well known. In these systems, music is stored digitally in a high-capacity magnetic storage device, such as a hard drive, to obviate the need for optical discs and vinyl records. For example, many portable units for personal enjoyment are widely available on the market.

However, none of these devices are suitable for use by the disc jockey professional. Specifically, these consumer units lack the ability to precisely cue music and set precise loop points within tracks. Furthermore the existing consumer units are not built within a rugged chassis; an essential for any disc jockey who must constantly move his or her equipment. Existing consumer units also lack dual media drives. Dual media drives are essential to the disc jockeys because disc jockeys must be able to play music while simultaneously readying for play the next song to be played. Consumer units also lack the ability to match the tempo of the music of different songs, commonly referred to as “beat matching.” Without this feature, disc jockeys cannot seamlessly transition from one song to the next without causing consternation among his audience. Thus, there is a need for such a digital storage-based music system that includes the necessary advanced features and functionality to satisfy the music professional.

### SUMMARY OF THE INVENTION

The present invention is a digital storage-based music system designed specifically for disc jockeys. The new and unique system provides a stand alone digital storage device that does not require a separate computer. Thus, an entire music library can be stored on the device. Uniquely, two (2) media readers are also included to provide unprecedented flexibility in music storage, play and control. For example, media can be streamed simultaneously from the digital storage device and tracks can be copied of “ripped” to the digital storage device in a compressed or uncompressed format for storage. The physical interface for mixing and controlling media is provided, as shown, which is not found in existing consumer type music personal portable devices. Many disc jockey specific enhancements are made to the device to make the device suitable for use by such disc jockeys. For example, music on the digital storage drive can be seamlessly looped and precisely cued.

Specifically, the digital media system for disc jockeys of the present invention includes a digital storage drive, such as a hard disk, that is capable of dual streaming of digital data. Preferably the music system has first media reader and a second media reader capable of reading digital data stored on removable media. An operating system is included for managing the digital data of the digital storage drive. The music system also includes an output and a control unit for controlling the media readers, digital storage drive, operating system, and output. The control unit has a first interface and a second interface. The first interface is capable of independently and selectively mixing digital data from the first media reader and the storage drive into a first signal and routing the first signal through the output. The second interface is capable of independently and selectively mixing digital data from the second media reader and the storage drive into a second signal and routing the second signal through the output.

In view of the foregoing, a superior disc jockey music playing system is provided which is completely new and unique from devices and systems known in the art. As a result, playing music by a disc jockey is greatly improved, enhanced and facilitated compared to prior art devices and systems.

### BRIEF DESCRIPTION OF THE DRAWINGS

These and other features, aspects, and advantages of the present invention will become better understood with reference to the following description, appended claims, and accompanying drawings where:

FIG. 1 is a perspective view of the preferred embodiment of the instant invention;

FIG. 2a is a front view of the preferred embodiment of the playback unit of the instant invention;

FIG. 2b is a rear view of the preferred embodiment of the playback unit of the instant invention;

FIG. 3a is a front view of the preferred embodiment of the control unit of the instant invention;

FIG. 3b is a rear view of the preferred embodiment of the control unit of the instant invention;

FIG. 4 is a close-up view of the preferred embodiment of the first interface of the instant invention;

FIG. 5 is a close-up view of the preferred embodiment of the display of the instant invention; and

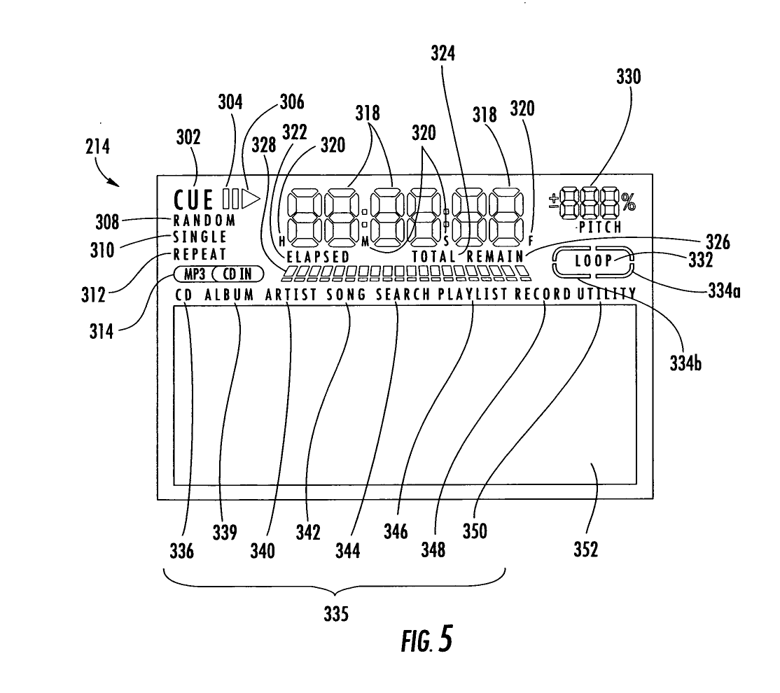

FIG. 6 is a perspective view of an alternative embodiment in a unitary housing.

### DESCRIPTION OF THE PREFERRED EMBODIMENT

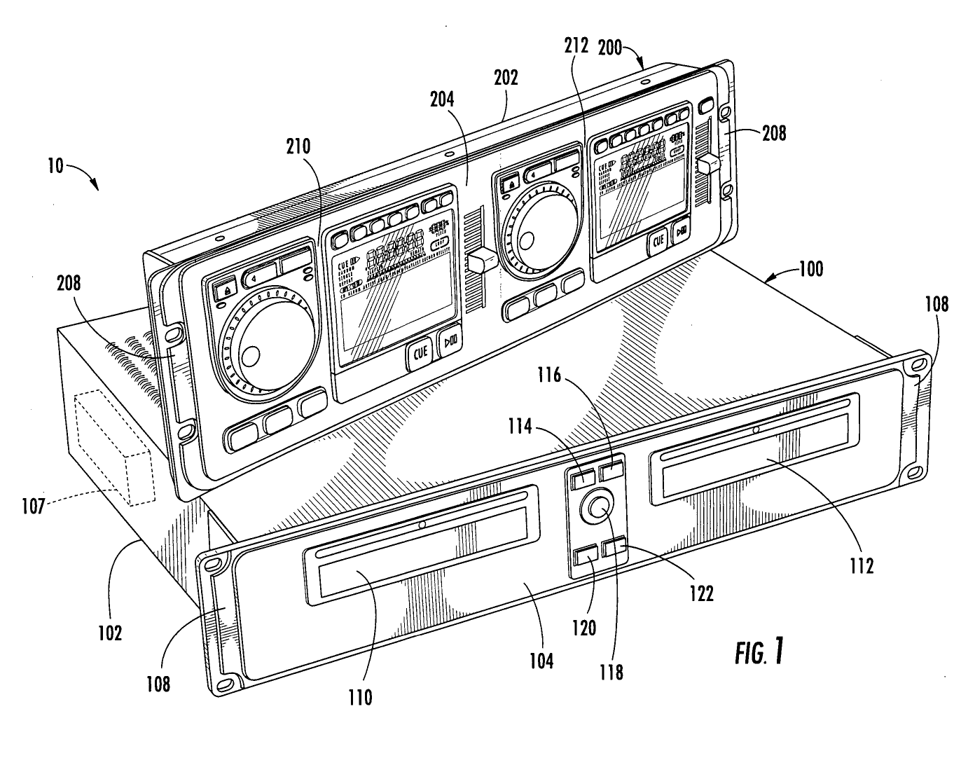

Referring now to FIG. 1, the preferred embodiment of the present invention is shown generally at 10. As will herein be more fully described, the digital music system of the present invention comprises a digital storage drive capable of dual streaming of data, two removable storage media readers, an operating system storing and managing the content of the digital storage drive, and a control unit for controlling the media reader and digital storage drive. The control unit has a first and a second interfaces configured in a format well suited for use by disc jockeys.

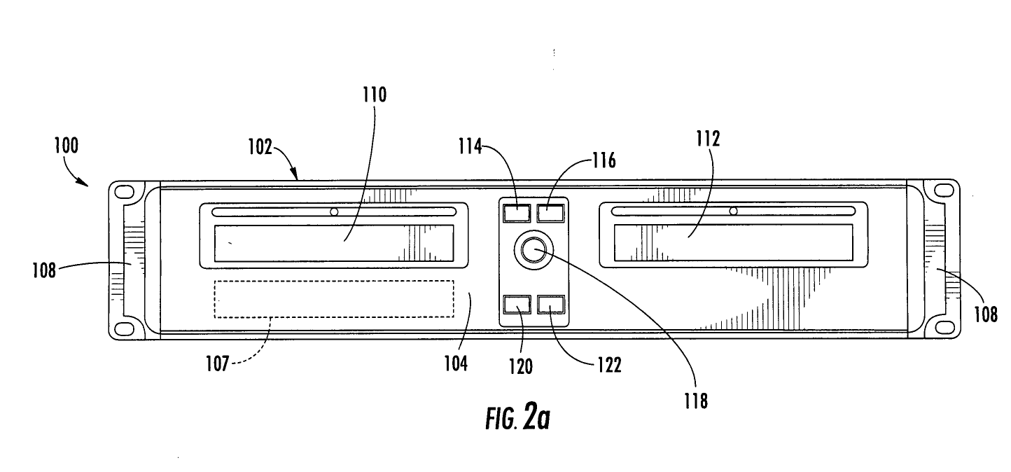

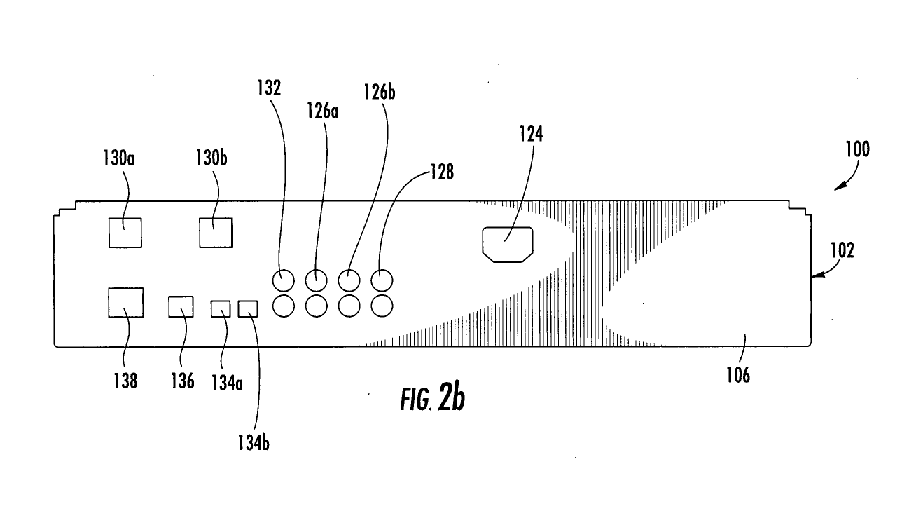

Referring now to FIGS. 1 and 2a, there are preferably two media readers 110, 1 12 contained in a separate playback unit 100. The playback unit 100 has a playback housing 102. The housing 102 has a front and a rear panel 104, 106. Extending from the edges of the playback housing 102 are rack mounts 108. The rack mounts 108 and playback housing 102 are configured so that the playback unit 100 is mountable within a standard nineteen-inch rack, which are commonly used by disc jockeys. Within the housing of the playback unit 100 are a first and second media readers 110, 112, which are preferably compact disc optical drives, but could be other removable-media type data readers such as DVD players, mini-disc players, or compact flash modules.

Access to load the media readers 110, 112 with appropriate media is gained through the front panel 104 of the playback unit 100 by activating the first and second eject controls 114, 116, which are located on the front panel 104 and between the first and second media readers 110, 112. To turn the digital music system 10 on and off, a power switch 118 is located on the front panel 104 of the playback unit 100 and just below the eject controls 114,116. Just below the power switch 118 are a front data port 120 and a front keyboard port 122. Preferably, the front data port is a universal serial bus compatible port, but other serial device connectors could be used.

Referring now to FIG. 2b, located on the rear panel 106 of the playback unit 100 are a number of connectors which include a power input 124, first and second line outputs 126a, 126b, line inputs 128, first and second controller connectors 130a, 130b, first and second digital outputs 132a, 132b, first and second optical digital outputs 134a, 134b, a rear data port 136, and a rear keyboard port 138. Collectively, the first and second outputs mentioned above, are all internally electrically connected to their respective media reader 110, 112. The power input 124 is connected to a power source (not shown) via a standard power cable (not shown) commonly used for consumer electronic devices. The first and second control connectors 130a, 130b are connected to the control unit 200, described in more detail below, to enable the control unit 200 to operate the playback unit 100. Preferably, the rear data port 136 is a universal serial bus compatible port, but other serial device connectors could be used.

Also located within the playback unit housing 102 of the playback unit 100, is a digital storage drive 107. Preferably, the digital storage drive 107 is a hard disc drive, but other devices could be used such as a large capacity flash memory. It is critical, however, that the digital storage drive 107 be capable of dual streaming of data. This feature is critical to the disc jockey because he or she must be able to play music stored on the drive and simultaneously ready for play, copy music from the media readers 110,112, or edit play lists stored on the drive during his or her performance. The disc jockey must be able to multi-task during a performance, and his or her equipment must support this role. Also, the digital storage drive 107 could easily be located within the control unit 200, described more fully below.

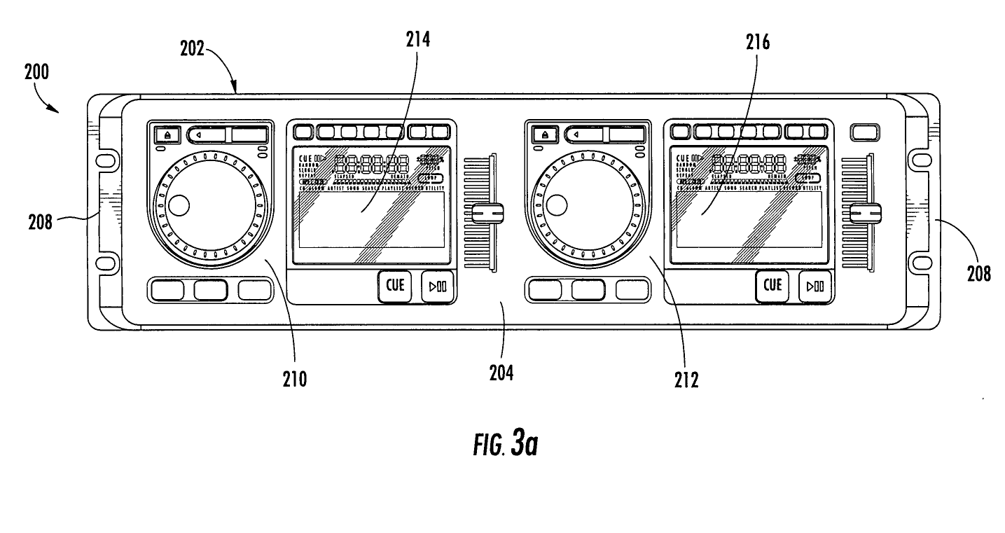

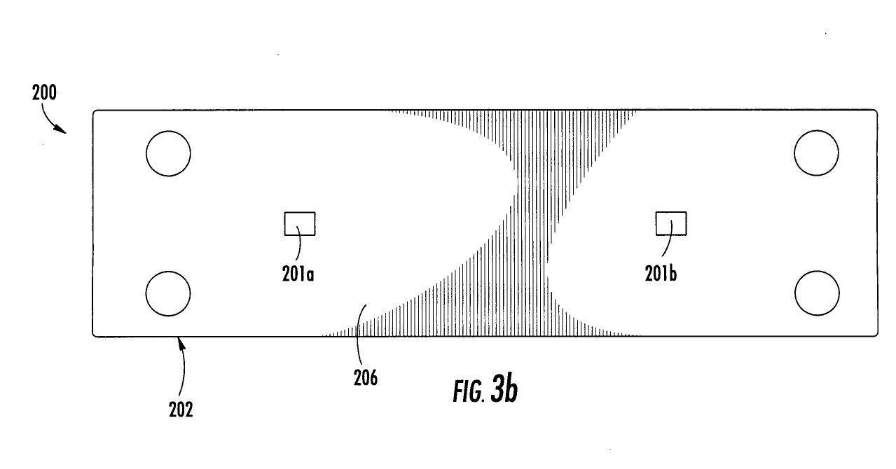

Referring back now to FIGS. 1 and 3a, the control unit 200 of the present invention has a control unit housing 202 with a front and a rear panel 204, 206. Extending from the edges of the control unit housing 202 are rack mounts 208. The rack mounts 208 and control unit housing 202 are configured so that the control unit 200 is mountable within a standard nineteen-inch rack, which are commonly used by disc jockeys. The control unit 200 has a first and a second interfaces 210, 212 located on the front panel 204. Each interface 210, 212 independently controls a corresponding media reader 110, 112 of the playback unit 100 via a number of controls that are arranged in substantially the same format as the other interface 210, 212. Each interface also has a display 214, 216 to inform the disc jockey of operation statistics, modes and content of the digital music system 10.

Referring now to FIG. 3b, on the rear panel 206 of the control unit housing 202 of the control unit 200, are first and second control connectors 201a, 201b. The first and second control connectors 201a, 201b are connected to the respective first and second control connectors 130a, 130b on the rear panel 106 of the playback unit housing 102 of the playback unit 100 via a pair of control cables (not shown).

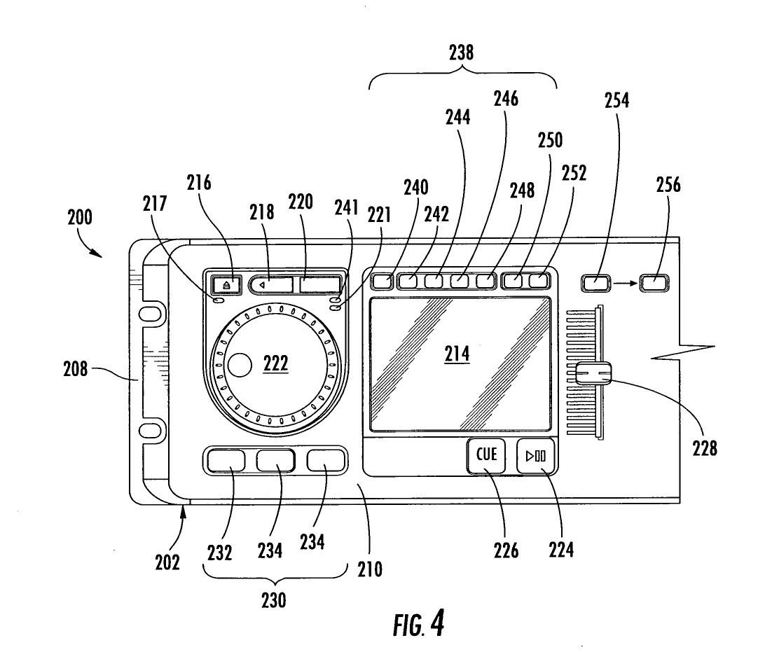

Referring now to FIG. 4, a close-up view of the first interface 210 is shown and will be discussed in detail below. It is to be understood, however, that this discussion is equally applicable to the second interface 212 and is merely explained only once as a matter of convenience. The first interface 210 has a display and a number of controls to control the functions of the digital music system 10 and several indicators to inform the disc jockey of various modes the digital music system 10 may have activated.

An open control 216 is located in the upper left corner. The open control 216 opens and closes the first media player 110 and is duplicative in function of the eject control 114 located on the playback unit 100. Just below the open control 216 is a disc-in indicator 217. The disc-in indicator 217 indicates whether a disc has been loaded into the media player 110. Adjacent to the open control 216 is a back control 218. During music catalog browsing (described more fully below), the back control 218 is used to go back to previous menu level. The back control 218 is also used to go back to the previous track when the digital music system 10 is in play mode. Adjacent to the back control 218 is a select control 220. Activating the select control 220 puts the jog wheel 222 (described below) into select mode. During browsing, the select control 220 is used to move to the next menu level including selecting a track and auto-cueing. The select control 220 is also used to verify choices entered by the disc jockey, and advance to the next track when the digital music system 10 is in play mode. Below the select control 220 is a select indicator 221, which indicates when the select control 220 has been activated.

The first interface 210 also has a jog wheel 222, which is freely rotatable about an axis and has four behaviors depending on the mode it is in. During play in play mode, the jog wheel 222 is used to make momentary adjustments to the tempo of the music being played, called a “pitch bend.” Rotating the jog wheel 222 clockwise increases the tempo momentarily, and rotating it counter-clockwise will momentarily decrease the tempo. This feature allows the disc jockey to make minute adjustments to the tempo in order to synchronize the bass beats of two different songs together, a technique called “beat matching,” to facilitate a seamless performance. During pause in play mode, the jog wheel 222 is used to find a new cue point. When the jog wheel 222 is rotated while the music is paused, the music will sound. The disc jockey can find the precise point within the song that he or she wishes to start from. During search mode, the jog wheel 222 either fast forwards or rewinds. During select mode, the jog wheel 222 is used in combination with the select control 220 (described earlier) to navigate through the menus.

Below the display is a play/pause control 224. Activating the play/pause control 224 a first time starts playback at the last set cue point. Activating the play/pause control 224 a second time pauses the playback and also puts the jog wheel 222 into pause in play mode. Activating the play/pause control 224 a third time restarts playback and sets a new cue point.

Adjacent to the play/pause control 224 is a cue control 226. Activating the cue control 226 while music is playing returns and pauses the music at the last set cue point. Activating and holding the cue control 226 a second time will play music from the cue point for as long as the cue control 226 is held. Activating the cue control 226 during select mode will bring the selected track into play mode and cues it to the beginning of the track.

Adjacent to the first display 214 is a pitch control 228. The pitch control 228 allows the disc jockey to permanently adjust the tempo of the music to speed it up or slow it down. The pitch control 228 also has a neutral position to return the music to its original tempo. The disc jockey uses the pitch control 228 in conjunction with the jog wheel 222 in play mode facilitate beat matching of the songs in disc jockey's performance.

Below the jog wheel 222 are a set of loop controls 230 including a loop-in control 232, a loop-out control 234 and a re-loop control 236. When activated, the loop-in control 232 sets a loop-in point for looping of music segments. By default, the loop-in point is also the initial cue point. Activating the loop-out control 234 sets a loop-out point. If the loop-out control 234 is activated during play will immediately return the playback to the loop-in point and proceed to play the music segment identified between the loop-in and loop-out points repeatedly until the loop-out control 234 is activated again. Activating the re-loop control 236 returns the playback of the music to the loop-in point and replays the music segment identified between the loop-in and loop-out points. The re-loop control 236 also has the function to perform a stutter.

Above the display and reading from left to right, are a set of function controls 238 including a search 240, info 242, time 244, mode 246, program 248, record 250, and save 252 controls. The search control 240 has two behaviors depending on the current mode the music system 10 is in. When the music system 10 is not in play mode, activating the search control 240 allows the disc jockey to use the jog wheel 222 to search and browse for music by artist, song, album and by playlist. When the music system 10 is in play mode, activating the search control 240 allows the disc jockey to use the jog wheel 222 to fast forward or rewind within the song.

The search control 240 automatically shuts off after eight (8) seconds of non-use in order to prevent inadvertent searching after the proper play point has been found. When the search control 240 is activated a search indicator 241 will indicate that the search control 240 is active. The search indicator if located below the select control 220 and just above the select indicator 221.

Adjacent to the search control 240 is an info control 242. Activating the info control 242 indicates all the data relevant to the current track selected or being played. This will be more fully described below. If the info control 242 is activated and held for two (2) seconds the music system 20 will enter edit mode to allow the disc jockey to change the title of the track and edit various other features. This feature is more fully described below.

Adjacent to the info control 242 is a time control 244. The time control 244 toggles the time data that will be displayed between elapsed playing time, remaining time on the track, and remaining time on the album or play list.

Adjacent to the time control 244 is a mode control 246. The mode control 246 toggles between several play modes including: continuous play of the album or play list; single play of a single track; random continuous play of an album of play list; repeat play of an album or play list; and single repeat play of a single track.

Adjacent to the mode control 246 is a program control 248. The program control, when activated, allows the disc jockey to create play lists and sequence tracks within them.

Adjacent to the program control 248 is a record control 250.

Activating the record control 250 will prompt the disc jockey to select either the media reader 110 or the line inputs 128 to record media. When media is within the media reader 110, the disc jockey will be presented with two options, either to rapid archive the contents of the CD or to save and compress the contents of the CD. These functions are more fully described below.

Adjacent to the record control 250 is a save/del control 252. The save/del control 252 is used to save edited information, play lists, and to execute commands to delete play lists and content.

Above the pitch control 228 is a relay control 254. When activated, the relay control 254 alternates play between the media sequenced in the first interface 210 and media sequenced in the second interface 212 as each sequence ends.

Adjacent to the relay control 254 is a utility control 256. The utility control 256, used in combination with the jog wheel 222, allows the disc jockey to activate following system functions: audio settings, password, enable auto door close, setting encoding bit rate, enabling CDDB look up, looking at the system capacity, checking the version number, delete songs, delete play lists, delete albums, defragmenting the storage drive, and formatting the storage drive. These functions are more fully described below.

Like the first interface and second interface 210, 212, the first display 214 and the second display 216 are identical to one another with the exception that the first display 214 primarily indicates characteristics of the first media reader 110 and the second display 216 primarily indicates characteristics of the second media reader 112. Therefore, it is to be understood that the following description of the first display 214 is equally applicable to the second display 216 and that it is described only once as a matter of convenience.

The first display 216 has a number of indicators, which inform the disc jockey of the various modes the music system 10 is in; various statistics of the media content the disc jockey has selected; and menus of various functions the disc jockey may activate to manage the music system 10.

In the upper left-hand corner of the display 216, is a cue indicator 302. The cue indicator 302 flashes when the disc jockey is setting a cue point. The cue indicator 302 lights continuously when the music system 10 is paused at a previously set cue point.

Adjacent to the cue indicator 302 is a pause indicator 304. The pause indicator 304 indicates when the music system 10 has been paused by activating the play/pause control 224.

Adjacent to the pause indicator 304 is a play indicator 306. The play indicator 306 indicates when the music system 10 is in play mode by acitivation of the play/pause control 224.

Beneath the cue, pause and play indicators 302, 304, 306 is a random indicator 308. The random indicator 308 indicates when the mode control 248 has been set to random play mode.

Beneath the random indicator 308 is a single indicator 310. The single indicator 310 indicates when the mode control 248 has been set to single repeat play mode.

Beneath the single indicator 310 is a repeat indicator 312. The repeat indicator 312 indicates when the mode control 248 has been set to repeat play mode.

Beneath the repeat indicator 312 is media type indicator 314. The media type indicator 314 indicates the type of media that has been loaded into the media reader 110 such as an MP3 formatted CD-Rom or an audio CD.

Adjacent to the play indicator 306 is a time display 316. The time display 316 had a number of components including three pairs of digit indicators 318 to represent time that has elapsed or remaining depending on the setting of the time control 244. Adjacent to each pair of digit indicators 318 are time units indicators 320. The time units indicators 320 indicate the time units that the digit indicators 318 represent. The time unit indicators 320 indicate whether the digit indicators 318 are display hours, minutes and seconds, or whether the digit indicators 318 are indicating minutes, seconds and frames. Below the digit indicators 318 are three indicators: elapsed 322, total 324, and remaining 326. The elapsed indicator 322 indicates that the time displayed by the digit indicators 318 is the total time elapsed. The remain indicator 326 indicates that the time displayed by the digit indicators 318 is the time remaining on a particular track. The total indicator 324 and remaining indicator 326, together, indicate that the time displayed by the digit indicators 318 is the total time remaining on the CD, album or play list (as appropriate).

Below the elapsed, total, and remaining indicators 322, 324, 326 is a time bar 328. The time bar 328 indicates graphically the time remaining, total time remaining or track elapsed time depending on the setting of the time control 244. Adjacent to the time display 316 is a pitch indicator 330. The pitch indicator 330 indicates current pitch setting of the music system 10.

Below the pitch display 330 loop indicator 332. The loop indicator 332 indicates if playback is currently playing between loop points.

Surrounding the loop indicator 332 is a loop ring indicator 334 including a first segment 334a and a chase segment 334b. The first segment 334a of the loop ring indicator 334 indicates when media selected by loop points is playing. The chase segment 334b of the loop ring indicator 334 indicates when a loop is playing.

Below the media type, time bar, and loop ring indicators 314, 328, 334 are a number of source and mode indicators 335 all in a row that indicate the source of playback and function modes of the music system 10. The source and mode indicators 335 include a CD 336, album 338, artist 340, song 342, search 344, play list 346, record 348, and utility 350 indicators.

Starting from the left, the CD indicator 336 indicates if the source of the playback is from the media player 110. Adjacent to the CD indicator 336 is an album indicator 338. The album indicator 338 indicates when an entire album is being played from the album list (described below). Adjacent to the album indicator 338 is an artist indicator 340. The artist indicator 340 indicates when playback is from the artist list (described below). Adjacent to the artist indicator 340 is a song indicator 342. The song indicator 342 indicates when playback is from the song list (described below). Adjacent to the song indicator 342 is a search indicator 344. The search indicator 344 indicates when the music system is in search mode. Adjacent to the search indicator 344 is a play list indicator 346. The play list indicator 346 indicates when playback is from a play list. Adjacent to the play list indicator 346 is a record indicator 348. The record indicator indicates when the music system 10 is recording. Adjacent to the record indicator 348 is a utility indicator 350. The utility indicator 350 indicates when the utility control 256 has been activated.

Below the source indicators 335 is a matrix text are 352. The matrix text area 352 displays a number of items such as track titles, programming text, and music system 10 information.

An operating system is included in the preferred embodiment of the present invention to manage the digital data stored on the digital storage drive 107 and the disc jockey's inputs into the control unit 200. In addition to the various controls discussed above, the disc jockey may enter inputs into the music system 10 through a series of menus. As discussed earlier, the disc jockey navigates and makes selections within the various menus using the jog wheel 222, back control 218, and select control 220. Activating the various menus is accomplished by activating the appropriate function control 238 or the utility control 256.

A critical component to the operating system is a database of music characteristics such as track title, album title, artist, genre, and playing time. One such commercial song information database is the CDDB owned and maintained by Gracenote Corp., but other competing services exist. These databases will be collectively referred to as Compact Disc Data Base (“CDDB”) throughout this disclosure for the convenience of the reader. The CDDB can be queried for information and updated with new information. Parallel to the CDDB is the file system database, which includes corresponding information for the music stored on the digital storage drive 107. The file system database contains not only the characteristics of the music, but also references to the playlists with which a particular track is listed and custom edits to the characteristic data entered by the disc jockey.

Upon powering up the music system 10, a splash screen will be displayed in the matrix text area 352 of the displays 210, 212. After displaying the splash screen, the operating system will query the media drives 110, 112 to detect if media are loaded in either of the drives 110, 112. If media is detected within either of the drives 110, 112, the operating system will attempt to identify the type of media loaded in the drives 110, 112, and will prompt the media type indicator 314 to display the appropriate value. The media type will also be displayed in an upper level menu. If no media are loaded in the drives or the media is unidentifiable, “No CD” will be displayed in the upper level menu instead. In addition to the media type, the upper level menu also has albums, genre, and play lists selections listed. If removable media is found within the media players 110, 112 on power-up of the music system 10, or removable media is loaded into the media players 110,112 while the music system is not currently playing music or in utility mode, the operating system will indicate the names of the tracks on the appropriate display 214, 216. To accomplish this feature, the operating system invokes a CDDB look-up function, which queries the CDDB for the corresponding information. If the query can not find the corresponding information, the tracks will be displayed in sequentially increasing track numbers. If the CDDB returns erroneous information or is otherwise unavailable, the disc jockey can toggle between the track number identification and the information found by activating the info control 242. The disc jockey can then use the jog wheel 222 and play/pause control 224 to start playing the song immediately, or the cure control 226 to put the playback point at the beginning of the track and in pause.

To descend into the upper level menu categories the disc jockey uses the jog wheel 222 to highlight the desired category and the select control 220 to open the category. For instance, if the artist category is selected the display 214, 216 will show a menu of the artists that have songs stored on the digital storage drive 107. Selecting a particular artist will open into a new menu, which lists the songs by that artist that are currently stored on the digital storage drive 107. The disc jockey can then select a song to play, cue, add to a play list or to delete. Descending into the genre category will prompt the operating system to activate a menu of different music genres available such as jazz, pop, alternative, and new age. Selecting a specific genre will prompt the operating system to activate a menu listing all of the current songs stored on the digital storage drive 107 that are categorized within that genre as identified by the CDDB and/or file system database.

The disc jockey can also search for music rather than browse through the menus. As described earlier, the search control 240 activates a search menu. The search menu presents the disc jockey with four options: search by artist, by album, by song, and by play list. The disc jockey makes his selection using the jog wheel 222 and activates either the select control 220 or search control 240 to confirm the selection. After the selection has been confirmed, the disc jockey will be presented with a search input screen.

The search input screen is where the disc jockey can enter an alphanumeric character string that the operating system will use to search the digital storage drive 107. The disc jockey has two methods he or she can use to enter the search string. First, the disc jockey can use a conventional keyboard connected to either the keyboard port 122 on the front panel 104 of the playback unit 100 or the keyboard port 138 on the rear panel 106 of the playback unit 100. Second, the disc jockey can use the jog wheel 222 and select control 220 to enter in a search string. Rotating the jog wheel 222 clockwise will scroll through the characters A through z and the digits 0 through 9. Rotating the jog wheel 222 counter clockwise will scroll through the same characters and digits, but in reverse order. If the disc jockey selects an incorrect character, the disc jockey can erase the entered character by activating the save/del control 252.

After the search string is entered, activating the search control 240 will prompt the operating system to start the search. A search result screen will be displayed by the operating system with a list of all songs that matched or partially matched the search string. A particular song may be selected for by using the jog wheel 222 and select control 220. Activating the back control 218 or the search control 240 will prompt the operating system to return to the upper level menu.

If the disc jockey desires to view more information about a particular song, such as the artist, album, play length, or compression rate, the disc jockey can activate the info control 244 while the song is selected. All the characteristics about the song as retrieved from the file system database, or CDDB as appropriate, will be displayed in a full song information screen. By activating and holding the info control 244 for two (2) seconds, the operating system is prompted to display the song information editing screen.

The song information editing screen allows the disc jockey to change the information characteristics of the song. The saved changes will be saved to the file system database. The disc jockey may want to do this because the song's information does not appear in the CDDB or the information retrieved form the CDDB is erroneous. The disc jockey uses the jog wheel 222 and select control 220 to select the characteristic that he or she desires to edit. Once the characteristic is selected, a cursor will appear that covers the width of one character.

The cursor initially appears over the first character. Activating the select control 220 advances the cursor one character. Activating the back control 218 retreats the cursor one character. The disc jockey uses either a keyboard or the jog wheel 222, as described in entering a search string, to enter any changes to the characteristic. If the disc jockey has no desire to change the information in a particular characteristic or wishes to abandon any changes made, activating the back control while the cursor is on the first character of the particular characteristic will allow the disc jockey to select another characteristic to edit using the jog wheel 222.

To save any changes made to the characteristic, the disc jockey activates the save/del control 252. Activating the info control 242 prompts the operating system to leave the song information editing screen and return to the upper level menu.

To create and sequence a play list, the disc jockey first searches or browses for the tracks he or she desires to add to a play list. Once the disc jockey finds a desired track, the disc jockey activates the program control 248 to add the track to the play list. Activating the program control 248 prompts the operating system to add the track to the play list, and to mark the selected track as having been added to the play list. Activating the program control 248 over a marked track will deselect the track from the play list and un-mark the track.

Once all the tracks that the disc jockey desires have been added to the play list, the disc jockey may save the play list by activating the save/del control 252. The operating system is prompted to display a current play list screen, which has a list of the selected tracks. Activating the save/del control 252 a second time prompts the operating system to save the play list. In order to complete the saving process, the operating system prompts the disc jockey to enter a name for the play list. The disc jockey may enter a name either using a keyboard or by using the jog wheel 222 and select control 220. If the disc jockey desires to change the name of the play list at a later time, the disc jockey may do so by selecting the play list using the jog wheel 222 and then activating and holding the info control 242 for two (2) seconds. The disc jockey may then edit the play list name like editing the characteristics of tracks described above.

If the disc jockey is unhappy with the order of the selected tracks or desires to add or delete some of the selected tracks, the disc jockey may activate the back control 218 and proceed to select additional tracks and deselect previously selected tracks. By selecting and deselecting tracks, the disc jockey may reorder the play list too.

If the disc jockey does not desire to save the current play list, but still wants to play the tracks in the current play list, the disc jockey can play the current play list by activating the play/pause control 224.

If the disc jockey does not want to play all of the tracks in the play list, the disc jockey can deselect the undesired tracks by selecting them with the jog wheel 222 and then activating the program control 248. The operating system is also prompted to un-mark the selected track.

A unique feature of the operating system of the music system 10 is the ability to record tracks from the media drives 110, 112 or a signal from the line inputs 128 and to compress the track or signal into a compact storage format such as—but not restricted to—MP3, MPEG-2, OGG, WMA, AAC, MLP, M4A. To record from a media player 110, 112 the disc jockey must load removable media into one of the media drives 110, 112, select either the title or a track using the jog wheel 222, and then activate the appropriate record control 250. Selecting the title field of the media will prompt the operating system to record the entire contents of the media. Selecting a particular track of the media will prompt the operating system to record only that track. Activating the record control prompts the operating system to enter record mode and to display a record options screen. The record options screen presents the disc jockey with a number of options. These options include: rapid archive, save and compress, and external line in. The rapid archive record option copies the track or album onto the digital storage drive 107 in a raw format. This feature is useful to the disc jockey during a performance as it allows the disc jockey to rapidly transfer tracks from media to the digital storage drive 107. The save and compress record option compresses the raw content of the media into a compressed format such as—but not restricted to—MP3, MPEG-2, OGG, WMA, AAC, MLP, M4A, according to the user defined settings set in the utility menu, described more fully below. The disc jockey uses the jog wheel 222 and select control 220 to make the desired choice. During recording, the operating system will update the matrix text area 352 of the appropriate display 214, 216 with its progress.

To record from the line inputs 128, the disc jockey selects the external line in option from the record options screen using the jog wheel 222 and then activating the play/pause control 224. The operating system will then start recording from the line inputs 128 and prompt the matrix text area 352 of the appropriate display 214, 216 to display an external line in screen. If the disc jockey desires to create tracks during recording of the line inputs 128, activating the record control 250 will prompt the operating system to mark the end of the of the current track and save it. The operating system will then continue to record from the line inputs 128 and assign a new sequential track number to the recording. The disc jockey can then later edit the names of the tracks using the info control 242 as described earlier. To stop recording the line inputs 128, the disc jockey activates the play/pause control 224 again. Activating the save/del control 252 causes the operating system to prompt the disc jockey to enter the values for the characteristics of the recording such as the name of the genre, album, artist and track. The disc jockey uses the jog wheel 222 and select control 220 to select the desired field to edit. The disc jockey then uses in combination the back control 218, select control 220 and jog wheel 222 to make the desired name change. The disc jockey confirms the name change by activating the save/del control 252. After entering the desired name changes for the relevant fields, activating the save/del control 252 again saves the recording to the digital storage drive 107 in the file system database.

As previously described, activating the utility control 256 invokes the operating system to display a utility menu screen. The Utility menu screen presents the disc jockey with a number of sub-menus including compression, delete, system, password and custom menus. The disc jockey enters a desired sub-menu by using the jog wheel 222 and select control 220 to select the desired sub-menu.

Selecting the compression sub-menu presents the disc jockey with the compression options screen. The compression options screen has three (3) settings the disc jockey can adjust. These settings are the sampling rate for the media drives 110, 112, the sampling rate for the line inputs 128, and the option to compress tracks previously rapid archived. The sampling rate for the media drives 110,112 can be adjusted between several settings. These settings include: 128 kbps, 320 kbps, and CD (PCM) audio. The higher the sampling rate the higher the sound quality will be of the resulting track, but it comes at the price of having a larger file. The option to compress previously recorded tracks that had been rapid archived, compresses the tracks into a compact storage format, and deletes the rapid archive file. This option is useful to the disc jockey as a house cleaning function after performances where the disc jockey transferred tracks from media to the digital storage drive 107 through the rapid archive feature.

Selecting the delete sub-menu presents the disc jockey with a deletion options screen. The deletion options screen first prompts the disc jockey for a password. The disc jockey enters the password using either the keyboard or the jog wheel 222 and select control 220. Setting a password is discussed in detail below. After entering a correct password, the operating system will present the disc jockey with a number of options. The options include searching: by album, by artist, by play list, and reformat. These options enable the disc jockey to search for particular tracks as they are categorized or to delete an entire category. For example, the disc jockey could delete all the tracks attached to a particular album or a particular track on the album. The play list option enables the disc jockey to delete the play list or to search for and delete particular tracks that are listed in the play list. The reformat option enables the disc jockey to delete the entire digital storage drive 107. When the disc jockey has selected the desired target to delete, activating the save/del control 252 prompts the operating system to confirm whether the disc jockey desires to proceed with deleting the target. The disc jockey activates the save/del control 252 again to confirm and execute the deletion.

Selecting the system sub-menu presents the disc jockey with a system options screen. The system options screen presents the disc jockey with a number of options. These options include: capacity, version number, firmware update, and defragment. Selecting the capacity option invokes a total capacity screen, which displays the characteristics of the digital storage drive 107 such as total size of the storage, remaining storage on the drive, the amount of space that could be saved through compression of uncompressed files, and remaining storage estimated in units (hours, minutes, seconds) of playing time. Selecting the version number option presents the disc jockey with the version information of the operating system. Selecting the firmware update option enables the disc jockey to update the operating system through a personal computer connected to either of the data ports 120, 136. Selecting the defragment option prompts the operating system to reallocate how the data is stored on the digital storage drive 107 for optimal access.

Selecting the password sub-menu presents the disc jockey with a password setting screen. The password setting screen enables the disc jockey to set a password to protect access to the music system 10. The operating system prompts the disc jockey to enter the old password. The disc jockey uses either a keyboard or the jog wheel 222, back control 218, and select control 220 to enter the old password. The disc jockey confirms the old password by activating the save/del control 252. After the disc jockey confirms the old password, the operating system prompts the disc jockey for the new password. The disc jockey uses the same procedure to enter in and confirm the new password. After the disc jockey confirms the new password, the new password is set.

Selecting the custom sub-menu presents the disc jockey with a custom options screen. The custom options screen presents the disc jockey with a number of options. These options include: enabling and disabling CDDB lookup, and setting a time period for auto-closing the doors on the media drives 110, 112. Selecting the CDDB lookup option enables the disc jockey to enable and disable the auto-lookup feature of the operating system. Selecting the auto-door closing option enables the disc jockey to set a time period to automatically close the access door to a media drive 110, 112 if it has been left open. This feature may also be disabled to prevent the media drives 110, 112 from automatically closing.

If the disc jockey connects the music system 10 to a personal computer via either of the data ports 120, 136, the operating system will display a connected screen informing the disc jockey of the connection. The disc jockey can then use software on the personal computer to upload and download media files and to manage all of the functions described above. Disconnecting the personal computer form the data port 120, 136 prompts the operating system to reset the music system 10.

In addition to managing the function of the music system 10, the software utility on the personal computer is capable of updating the firmware, i.e. operating system, of the music system 10. This valuable feature means not only can the disc jockey have the latest available software, but it also allows the manufacturer to release a product earlier to market, and reduces service costs and down time for both the customer and manufacturer. The software utility can also transfer songs between the music system 10 and personal computer; delete songs; allow editing song ID tag data stored in the file system of the music system 10; create, edit and delete playlists and playlist data; allow updating of the CDDB information. Furthermore the software utility may export a complete list of all songs stored in the music system 10. The resulting list may be inserted into any other database or spreadsheet program such as Microsoft Access or Excel programs. These features are very useful for the disc jockey who wants to share a list of his/her music with a client. The software utility also allows the formatting of a new digital storage drive 107 to work with the music system 10. This is important to allow users to upgrade their music system 10 with a digital storage drive 107 having a larger total storage capacity.

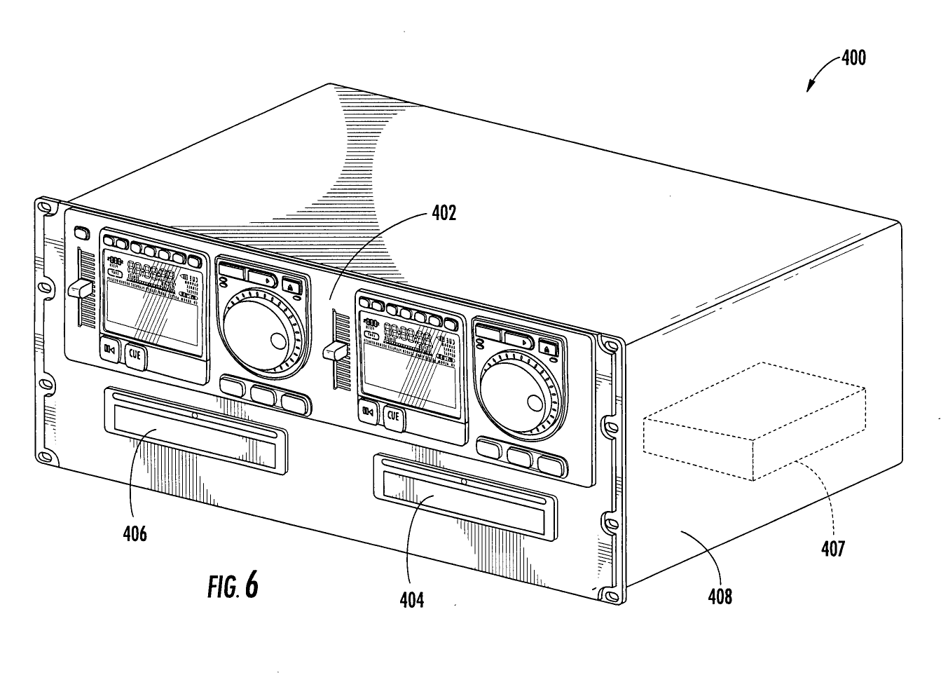

Although the present invention has been described in considerable detail regarding a certain preferred embodiment, other versions are possible. For example, FIG. 6 shows an alternative embodiment of a music system 400 of the present invention where the control unit 402, first media reader 404, second media reader 406, and digital storage drive 407 are contained within a single main housing 408. It should be understood that the functionality of the music system 400 is the same as the music system 10 of the preferred embodiment of the present invention as discussed in detail above. Some users of the present invention may prefer a single housing 408 rather than the separate housings 102, 202 of the preferred embodiment 10.

Therefore, it would be appreciated by those skilled in the art that various changes and modifications can be made to the illustrated embodiments without departing from the spirit of the present invention. All such modifications and changes are intended to be covered by the appended claims.

1. A system for playing digital media, comprising:
a digital data storage device;
means for playing the digital data on the digital data storage device to provide a first signal;
at least one media reader communicatingly connected to the digital data storage device; the media reader capable of reading digital data stored on removable media to provide a second signal and transferring the digital data to the digital data storage device;
means for playing the digital data on the removable media to provide a second signal;
an output communicatingly connected to the first signal and the second signal; and
a control unit having a first interface and a second interface; the first interface including means for independently controlling playback of digital data stored in the digital data storage device; the second interface including means for independently controlling playback of digital data stored on removable media being read by the at least one media reader.

2. The system of claim 1, wherein the at least one media reader is a pair of compact disc optical drives.

3. The system of claim 1, further comprising rack mounts.

4. The system of claim 1, further comprising:
a first housing for containing the control unit; and
a second housing for containing the playback unit.

5. The system of claim 4, further comprising:
first rack mounts extending from the first housing; and
second rack mounts extending from the second housing.

6. The system of claim 1, wherein the digital storage drive is a hard disk.

7. The system of claim 1, further comprising means for copying the digital data from the at least one media to the digital data storage device.

8. The system of claim 7, further comprising means for converting the digital data to a compressed media format,

9. The system of claim 1, further comprising:
a first pitch control unit within the first user interface;
a second pitch control unit within the second user interface;
the first pitch control and the second pitch control each being adjustable to enable the respective pitches of the first signal and the second signal to match each other.

10. The system of claim 1, further comprising:
a first pitch bend control that changes the pitch of the first signal; and
a second pitch bend control that changes the pitch of the second signal.

11. The system of claim 1, further comprising means for seamlessly looping the first signal.

12. The system of claim 1, further comprising means for seamlessly looping the second signal.

13. The system of claim 1, further comprising means for cueing the first signal to a desired playback position thereof.

14. The system of claim 1, further comprising means for cueing the second signal to a desired playback position thereof.

15. The system of claim 1, further comprising a display capable of indicating characteristics of the first signal and the second signal.

16. The system of claim 1, further comprising:
a first display capable of indicating characteristics of the first signal; and
a second display capable of indicating characteristics of the second signal.

17. A media system for disc jockeys, comprising:
a playback unit including a first media reader and a second media reader capable of reading data from removable storage media, a digital storage drive, a first output, and a second output;
an operating system for managing the digital data of the digital storage drive and capable of reading data from the first media reader and the second media reader of the playback unit and writing that data to the digital storage drive; and
a control unit for controlling the first media reader, the second media reader, digital storage drive, ripping means, and output; the control unit having a first interface and a second interface; the first interface capable of independently and selectively playing digital data from the first media reader and the digital storage drive as a first signal and routing the first signal through the first output; the second interface capable of independently and selectively playing digital data from the second media reader and the digital storage drive as a second signal and routing the second signal through the second output.

18. The media system of claim 17, further comprising:
first rack mounts extending from the playback unit; and
second rack mounts extending from the control unit

19. The media system of claim 17, wherein the first media reader is a compact disc compatible player and the second media reader is a compact disc compatible player.

20. The media system of claim 17, wherein the digital storage drive is a hard disk.

21. The media system of claim 17, wherein the digital data is stored on the digital storage drive in a compressed format.

22. The media system of claim 17, further comprising:
a first pitch control unit within the first user interface;
a second pitch control unit within the second user interface;
the first pitch control and the second pitch control each being adjustable to enable the respective pitches of the first signal and the second signal to match each other.

23. The media system of claim 17, further comprising:
a first pitch bend control that changes the pitch of the first signal; and
a second pitch bend control that changes the pitch of the second signal.

24. The media system of claim 17, further comprising means for seamlessly looping the first signal.

25. The media system of claim 17, further comprising means for seamlessly looping the second signal.

26. The media system of claim 17, further comprising means for cueing the first signal to a desired playback position thereof.

27. The media system of claim 17, further comprising means for cueing the second signal to a desired playback position thereof.

28. The media system of claim 17, further comprising a display capable of indicating characteristics of the first signal and the second signal.

29. The media system of claim 17, further comprising:
a first display capable of indicating characteristics of the first signal; and
a second display capable of indicating characteristics of the second signal.

30. A digital music system for disc jockeys, comprising:
a playback unit including rack mounts, a first compact disc player, a second compact disc player, a hard drive, a first output, and a second output;
a software program for managing the digital data of the digital storage drive and capable of reading digital stored music from the first compact disc player and second compact disc player of the playback unit and writing the digital stored music to the hard drive; and
a control unit for controlling the first compact disc player, second compact disc player, hard drive, software program, and output; the control unit having a rack mounts, a first display, a second display, a first interface, and a second interface;
whereby the first interface capable of independently and selectively playing digital stored music from the compact disc player and the hard drive as a first signal and routing the first signal through the first output;
whereby the second interface capable of independently and selectively playing digitally stored music from the second music player and the hard drive as a second signal and routing the second signal through the second output; and
whereby the first display indicates characteristics of the first signal and the second display indicates characteristics of the second signal.

31. The music system of claim 30, further comprising:
a first pitch control unit within the first user interface;
a second pitch control unit within the second user interface;
the first pitch control and the second pitch control each being adjustable to enable the respective pitches of the first signal and the second signal to match each other.

32. The music system of claim 30, further comprising:
a first pitch bend control that changes the pitch of the first signal; and
a second pitch bend control that changes the pitch of the second signal.

33. The music system of claim 30, further comprising means for seamlessly looping the first signal.

34. The music system of claim 30, further comprising means for seamlessly looping the second signal.

35. The music system of claim 30, further comprising means for cueing the first signal to a desired playback position thereof.

36. The music system of claim 30, further comprising means for cueing the second signal to a desired playback position thereof.

37. A system for playing digital audio files, comprising:
a first digital storage device for storing digital audio files;
means for playing the digital audio files on the first digital storage device to provide a first audio signal;
a second digital storage device for storing digital audio files;
means for playing the digital audio files on the second digital storage device to provide a second audio signal;
a control unit having a first interface and a second interface; the first interface including means for independently controlling playback of the first digital audio signal; the second interface including means for independently controlling playback of the second digital audio signal.

38. The system of claim 37, wherein the first digital storage device is a hard drive that is capable of simultaneously playing back and storing digital audio files.

39. The system of claim 37, wherein the second digital storage device is an optical compact disc reader.
